(19) United States
(12) Patent Application Publication
(10) Pub. No.: US 2022/0390909 A1
(43) Pub. Date: Dec. 8, 2022

(54) LEARNING DEVICE, LEARNING METHOD, AND LEARNING PROGRAM

(71) Applicant: NEC CORPORATION, Minato-ku, Tokyo (JP)

(72) Inventors: Dai KUBOTA, Tokyo (JP); Riki ETO, Tokyo (JP)

(73) Assignee: NEC Corporation, Minato-ku, Tokyo (JP)

(21) Appl. No.: 17/775,395

(22) PCT Filed: Nov. 14, 2019
(86) PCT No.: PCT/JP2019/044624

§ 371 Date: May 9, 2022

(51) Int. Cl. G05B 13/02

(52) U.S. Cl. CPC G05B 13/0265

(57) ABSTRACT

A learning unit 80 includes an input unit 81, a reward function estimation unit 82, and a temporal logic structure estimation unit 83. The input unit 81 receives input of an action history of a worker who performs multiple tasks in time series. The reward function estimation unit 82 estimates a reward function for each task in time series based on the action history. The temporal logic structure estimation unit 83 estimates a temporal logic structure between tasks based on a transition condition candidate at a point in time when each estimated reward function switched.

### TECHNICAL FIELD

The present invention relates to a learning device, a learning method, and a learning program for estimating a reward function considering temporal logic structure.

### BACKGROUND ART

If skilled skills cannot be reproduced due to a lack of successors to skilled engineers, skilled skills may cease to exist. In addition, although the driving automation of robots and automobiles is being promoted, it is difficult to manually set an objective function for the automation of robots and automobiles, so the setting of the objective function is one of the factors that hinder the automation. Therefore, attempts are being made to further develop the technology by simplifying the formulation of the objective function.

Inverse reinforcement learning is known as one of the methods for simplifying the formulation. Inverse reinforcement learning is a learning method that estimates an objective function (reward function) for evaluating actions in each state based on the history of decision-making made by an expert. In inverse reinforcement learning, the reward function of a expert is estimated by updating the reward function so that the history of decision-making approaches that of the expert.

Non-patent literature 1 describes maximum entropy inverse reinforcement learning, which is one of inverse reinforcement learning. In the method described in Non-patent literature 1, only one reward function R (s, a, s′)=θ·f(s, a, s′) is estimated from the expert's data D={τ₁, τ₂, . . . , τ_{N}} (where τᵢ=((s₁, a₁), (s₂, a₂), . . . , (s_{N}, a_{N})), where sᵢ represents a state and aᵢ represents an action). By using this estimated θ, the decision-making of an expert can be reproduced.

Further, Non-Patent literature 2 and Non-Patent literature 3 describe time-series inverse reinforcement learning for learning sequentially multiple reward functions from a data series. In time-series inverse reinforcement learning, the reward function and transition function to be switched are estimated from a single data series, assuming that the switching of the reward function does not depend on the past history.

With regard to sequentially changes, Non-patent literature 4 and Non-patent literature 5 describe methods for estimating temporal logic. In the estimation of temporal logic, the temporal logic structure between tasks possessed by an expert is estimated when the expert data are represented by multiple tasks (one task corresponds to one reward function) in a temporal logic framework.

Non-patent literature 6 also describes a normalization that suppresses the number of tasks across different trajectories in inverse reinforcement learning.

### CITATION LIST

### Non-Patent Literature

NPL 1: B. D. Ziebart, A. Maas, J. A. Bagnell, and A. K. Dey, “Maximum entropy inverse reinforcement learning”, In AAAI, AAAI'08, 2008.
NPL 2: Nguyen, Q. P., Low, B. K. H., & Jaillet, P, “Inverse reinforcement learning with locally consistent reward functions”, In Advances in neural information processing systems, pp. 1747-1755, 2015.
NPL 3: Krishnan, S., Garg, A., Liaw, R., Miller, L., Pokorny, F. T., and Goldberg, K., “Hirl: Hierarchical inverse reinforcement learning for long-horizon tasks with delayed rewards”, arXiv preprint arXiv:1604.06508, 2016.
NPL 4: Shah, A., Kamath, P., Shah, J. A., & Li, S., “Bayesian inference of temporal task specifications from demonstrations”, In Advances in Neural Information Processing Systems, pp. 3804-3813, 2018.
NPL 5: Vazquez-Chanlatte, M., & Seshia, S. A., “Learning Task Specifications from Demonstrations via the Principle of Maximum Causal Entropy”, arXiv preprint arXiv:1907.11792, 2019.
NPL 6: Adam Gleave, Oliver Habryka, “Multi-task Maximum Entropy Inverse Reinforcement Learning”, 1st Workshop on Goal Specifications for Reinforcement Learning (ICML/IJCAI/AAMAS 2018), July 2018.

### SUMMARY OF INVENTION

### Technical Problem

The inverse reinforcement learning described in Non-patent literature 1 assumes that a series of actions can be described by only one objective function (reward function). More generally, however, since the reward function to be set is not always one for a series of actions, it is preferable to be able to set a reward function considering past history and includes time changes and even switching according to situations.

The time-series inverse reinforcement learning described in Non-patent literature 2 and Non-patent literature 3 estimates the reward function by considering the time-series order of tasks, but it cannot consider the temporal logic structure in the task. Therefore, the time-series inverse reinforcement learning described in Non-patent literature 2 and Non-patent literature 3 may not reproduce the correct expert's action.

On the other hand, a solver for the Satisfiability Problem (SAT) is used to estimate the temporal logic. In general, when the size of the proposition set P, which is the source of transition conditions between tasks, is large, estimation of temporal logic is a non-deterministic polynomial (NP)-complete problem, which requires a large amount of computation time. Therefore, the methods described in Non-patent literature 4 and Non-patent literature 5 require a lot of search costs when the number of transition condition candidate between tasks becomes huge.

Therefore, it is an exemplary object of the present invention to provide a learning device, a learning method, and a learning program capable of efficiently estimating a reward function considering temporal logic structure between tasks.

### Solution to Problem

A learning device according to the exemplary aspect of the present invention includes an input unit which receives input of an action history of a worker who performs multiple tasks in time series, a reward function estimation unit which estimates a reward function for each task in time series based on the action history, and a temporal logic structure estimation unit which estimates a temporal logic structure between tasks based on a transition condition candidate at a point in time when each estimated reward function switched.

A learning method according to the exemplary aspect of the present invention includes receiving input of an action history of a worker who performs multiple tasks in time series, estimating a reward function for each task in time series based on the action history, and estimating a temporal logic structure between tasks based on a transition condition candidate at a point in time when each estimated reward function switched.

A learning program according to the exemplary aspect of the present invention causes a computer to execute an input process of receiving input of an action history of a worker who performs multiple tasks in time series, a reward function estimation process of estimating a reward function for each task in time series based on the action history, and a temporal logic structure estimation process of estimating a temporal logic structure between tasks based on a transition condition candidate at a point in time when each estimated reward function switched.

### Advantageous Effects of Invention

According to the exemplary aspect of the present invention, it is possible to efficiently estimate a reward function considering temporal logic structure between tasks.

### BRIEF DESCRIPTION OF DRAWINGS

FIG. 1 It depicts a block diagram showing a configuration example of an exemplary embodiment of a learning device according to the present invention.

FIG. 2 It depicts an explanatory diagram showing an example of time-series inverse reinforcement learning.

FIG. 3 It depicts an explanatory diagram showing an example of the process of estimating the reward function for each task in time series.

FIG. 4 It depicts an explanatory diagram showing an example of an automaton structure between tasks.

FIG. 5 It depicts a flowchart showing an operation example of the learning device.

FIG. 6 It depicts an explanatory diagram showing a specific example of a temporal logic task.

FIG. 7 It depicts an explanatory diagram showing examples of an estimated transition structure and a transition condition.

FIG. 8 It depicts a block diagram showing an overview of the learning device according to the present invention.

FIG. 9 It depicts a summarized block diagram showing a configuration of a computer for at least one exemplary embodiment.

### DESCRIPTION OF EMBODIMENTS

Hereinafter, an exemplary embodiment of the present invention will be described with reference to the drawings.

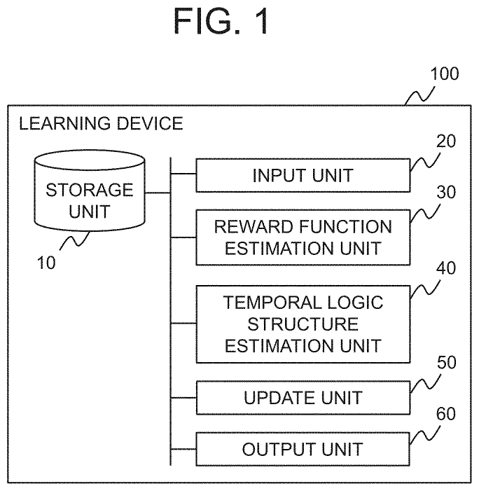

FIG. 1 is a block diagram showing a configuration example of an exemplary embodiment of a learning device according to the present invention. The learning device 100 of this exemplary embodiment comprises a storage unit 10, an input unit 20, a reward function estimation unit 30, a temporal logic structure estimation unit 40, an update unit 50, and an output unit 60.

In this exemplary embodiment, as described in Non-patent literature 2 and Non-patent literature 3, it is assumed that one or more tasks (sometimes written as a task) are included in the action history of the worker. The learning device 100 is a device that estimates a reward function considering the temporal logic structure between these tasks.

The storage unit 10 stores information necessary for the learning device 100 to perform various processes. The storage unit 10 may store various parameters used for the process by the reward function estimation unit 30, the temporal logic structure estimation unit 40, and the update unit 50 described below. The storage unit 10 may also store an action history received by the input unit 20 described below. The storage unit 10 is realized by a magnetic disk or the like, for example.

The input unit 20 receives an input of the action history of the subject. For example, when learning is based on the actions of an expert (skilled person), the input unit 20 receives the input of the action history of the expert who is the subject.

As described above, in this exemplary embodiment, it is assumed that the action history (sometimes written as trajectory) τ including one or more tasks of the subject is used, and the input unit 20 receives input of data (expert trajectory data) D including multiple action histories of the expert. That is, D={τ₁, τ₂, . . . , τ_{M}} and τ={(s₁, a₁), (s₂, a₂), . . . , (s_{N}, a_{N})}. Here, s indicates a state and a indicates an action.

In addition, the input unit 20 may receive input of a transition condition candidate. The transition condition here are a condition that specifies transitions between tasks, and are a logical formula expressed using a set P of propositional logical variables p (propositional set P) derived in advance from the domain knowledge to be learned. Instead of receiving input of a transition condition candidate by the input unit 20, the transition condition candidate may be stored in advance in the storage unit 10.

For example, assume a situation in which a robot arm performs a task (for example, Pick and Place). In this case, an example of state s is (“camera image”, “coordinates, axis angle, and speed (rotation speed) of each arm joint”), and an example of action a is (“torque in each joint”). Also, it is conceivable that the proposition set P includes where {p=“the distance between the object and the arm is less than X”, q=“picking the object”, r=“the distance between the arm and the box is less than Y” } as three propositional logical variables p, q, and r.

The reward function estimation unit 30 estimates reward function for each task in time series based on the received action history. Specifically, the reward function estimation unit 30 learns sequentially a plurality of reward functions for each task from a data series indicating the action of the worker included in the action history by time series inverse reinforcement learning which is a method of learning sequentially multiple reward functions from the data series. In the time series inverse reinforcement learning, it is estimated which time step interval [tᵢ, tᵢ₊₁] is generated based on one type of reward function in each trajectory τ.

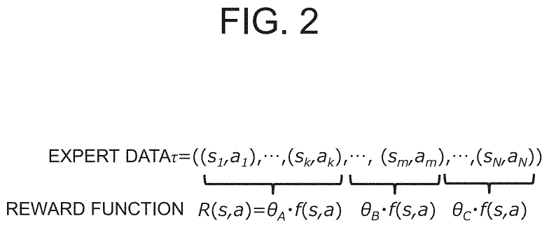

FIG. 2 is an explanatory diagram showing an example of time series inverse reinforcement learning. In the example shown in FIG. 2, for the expert data τ={(s₁, a₁), (s₂, a₂), . . . , (s_{N}, a_{N})}, three reward functions were estimated sequentially by time-series inverse reinforcement learning. Note that f (s, a) is a feature vector. Specifically, in the example shown in FIG. 2, it is shown that the reward function identified by the parameter θ_{A} is estimated for the data series from t=1 to k, the reward function identified by the parameter θ_{B} is estimated for the data series from t=k+1 to m, and the reward function identified by the parameter θ_{C} is estimated for the data series from t=m+1 to N.

The reward function estimation unit 30 may estimate a time-series reward function for each element of data D and output a label (hereinafter, written as a task label) to identify the task (reward function) at each time assigned to data D. For example, in the example shown in FIG. 2, the task label (Task-A) set for the data series from t=1 to k may be output, the task label (Task-B) set for the data series from t=k+1 to m may be output, and the task label (Task-C) set for the data series from t=m+1 to N may be output.

For example, the reward function estimation unit 30 may estimate the reward function for each task in time series by using the time-series inverse reinforcement learning described in Non-patent literature 2 and Non-patent literature 3, and by using a likelihood maximization and other methods. Furthermore, the reward function estimation unit 30 may perform normalization with respect to the number of tasks during learning in order to prevent an excessive number of tasks from being estimated from a single trajectory. Specifically, the reward function estimation unit 30 may estimate the reward function for each task in time series by optimizing the objective function including the regularization term shown in Equation 1 below.

$$[ Math . 1 ]$$

$$- α \vert {N}_{task} \vert - β {\sum }_{τ ∈ D} {\sum }_{t} ‖ {θ}_{t + 1} - {θ}_{t} ‖ \qquad ( Equation 1 )$$

In Equation 1, Nₜₐₛₖ is the number of different tasks currently estimated in the whole set of expert trajectories τ. θₜ is the weight of the reward function Rₜ in time step t (i.e. Rₜ=θ_{f}·f(sₜ, aₜ, sₜ₊₁)). In addition, a and 13 are coefficients of each normalization term.

Specifically, the first term in Equation 1 is a normalization term related to the number of tasks that appear in expert data, and is a term that takes on smaller values as the number of tasks increases. Further, the second term in Equation 1 is a normalization term related to a change in tasks estimated with time change, and is a term that takes a small value as the task changes.

That is, there are generally innumerable reward functions Rₜ that realize the change from (sₜ, aₜ) to (sₜ₊₁, aₜ₊₁). However, the actual action of the expert does not change at a dizzying pace at each step. Therefore, the number of reward functions to be considered for each action is considered to be only a few for each trajectory. Therefore, by considering a normalization term for changes of the reward function Rₜ sequentially, it is possible to estimate an action closer to an actual expert.

The reward function estimation unit 30 may also suppress the number of tasks across different trajectories using, for example, the method described in Non-patent literature 6. Specifically, the reward function estimation unit 30 may perform normalization with respect to the reward function θ estimated for each trajectory using Equation 2 shown below.

$$[ Math . 2 ]$$

$$\begin{matrix}{L}_{i} ( {θ}_{i} ) = {\sum }_{t} log P ( {τ}_{i}^{( t )} ) + γ {‖ {θ}_{i} - θ ‖}^{2} & ( Equation 2 )\end{matrix}$$

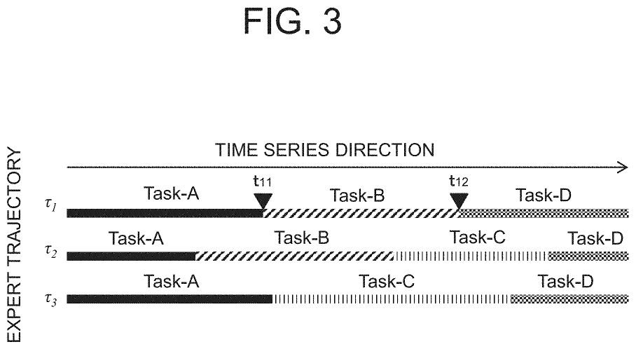

FIG. 3 is an explanatory diagram showing an example of the process of estimating the reward function for each task in time series. In the example shown in FIG. 3, it is shown that the three action histories (trajectories) could be classified into tasks identified by four types of task labels (Task-A to Task-D) in time series. Since a reward function is estimated for each task, it can be said that four types of reward functions are estimated in time series in the example shown in FIG. 3.

For example, it is estimated that the trajectory τ₁ illustrated in FIG. 3 switches from Task-A to Task-B at time t₁₁, and switches from Task-B to Task-D at time t₁₂. That is, it can be said that it is estimated that the reward function indicating Task-A switches to the reward function representing Task-B at time t₁₁, and the reward function indicating Task-B switches to the reward function representing Task-D at time t₁₂.

The temporal logic structure estimation unit 40 estimates a temporal logic structure between tasks (between tasks) based on a transition condition candidate at a point in time when each estimated reward function (task) switched. In the following description, the transition conditions between tasks are represented by φ. The transition condition candidate can be said to be a combination of a logical formula using a propositional logic variable.

The temporal logic structure estimation unit 40 of this exemplary embodiment focuses on the point in time when the task switches, and estimates the transition structure and the transition conditions between tasks as the temporal logic structure from the true/false values (sometimes called propositional variable information) of logical formulas using propositional logic variables before and after the switch. The temporal logic structure estimation unit 40 may, for example, estimate the transition structure of each task based on the time-series task labels after they are estimated by the reward function estimation unit 30. For example, if it is estimated that only Task-B or Task-C is executed after Task-A at the time of estimation, the temporal logic structure estimation unit 40 may estimate an automaton structure (state transition diagram) including directed graphs showing Task-A→Task-B and Task-A→Task-C as a temporal logic structure.

In addition, the temporal logic structure estimation unit 40 may estimate a transition condition between tasks from the true/false values (sometimes called propositional variable information) of logical formulas using propositional logic variables before and after the switch by using a solver for the satisfiability problem (SAT),

Furthermore, when considering noise and errors in expert data, it may be difficult for a satisfiability problem solver to estimate a transition condition. Therefore, the temporal logic structure estimation unit 40 may estimate a transition condition by calculating a transition probability between tasks. Specifically, the temporal logic structure estimation unit 40 may estimate the transition condition φ_{AB} from Task-A to Task-B using Equation 3 shown below.

φ_{AB}=argmax_{φ∈Φ}P(φ|D={τ₁,τ₂, . . . }) (Equation 3)

In Equation 3, Φ is the set of transition conditions and φ is a proposition that can be constructed from each element p (=propositional logic variable) of the propositional set P. The right side in Equation 3 is calculated by sampling or the like.

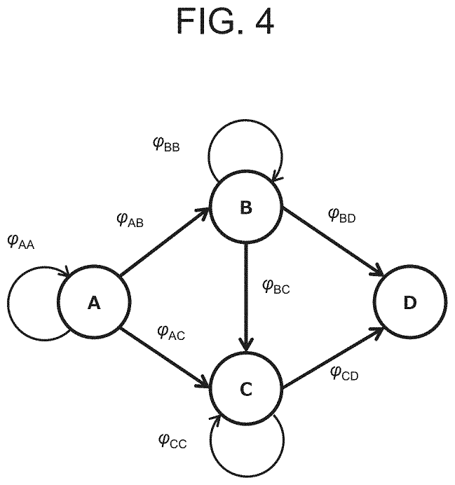

FIG. 4 is an explanatory diagram showing an example of an automaton structure between tasks. φ illustrated in FIG. 4 is a temporal logical formula consisting of a propositional logic variable p∈P, indicating the transition condition between each task.

In addition, the temporal logic structure estimation unit 40 may estimate the temporal logic structure between tasks using the methods described in Non-patent literature 4 and Non-patent literature 5.

For example, it is considered that the reward function considering the temporal logic structure between tasks can be estimated by simply combining the method of learning the reward function and the method of learning the temporal logic of the task. However, a simple combination of the two would only result in an inverse reinforcement learning process (processing loop) within the temporal logic learning process (processing loop). Such a combination is not realistic, since it would further increase the learning process, which even by itself requires a huge computational cost.

In other words, learning the temporal logic of a task is done a priori given a propositional set and then using a satisfiability problem solver, but this process is NP-complete. With sufficient domain knowledge, there is little need to learn the temporal logic of a task, so temporal logic learning is generally performed when domain knowledge is insufficient. In this case, however, a propositional set P of sufficient size must be set. Since the larger the size, the more difficult the computation becomes, it is also necessary to efficiently select the propositional logic variables in this propositional set P in order to reduce processing.

Here, as an example of a task, consider the task of “opening a locked door to escape”. If there is domain knowledge, it can be seen that only a propositional variable that represents {“whether the key was obtained”} need to be prepared as a propositional set P. However, if there is no domain knowledge, for example, it is assumed that the conditions under which the door opens are unknown. In this case, since it is not possible to determine whether or not the propositional variable {“whether the key was obtained”} is sufficient, other propositional variables (for example, “100 steps advanced” and “100 seconds have passed”) must also be prepared, and the size of the propositional set becomes large.

Furthermore, in this case, in order to reduce the size of the propositional set based on domain knowledge, it is also necessary to appropriately select the proposition set from the features indicated by the expert data from which the learning is based. For example, in the above example, if it can be understood from the expert data that the doors are all opened within 100 steps, it can be seen that the propositional variable (“100 steps advanced”) can be deleted. By appropriately selecting propositional variables (feature selection) in this way, the size of the propositional set can be reduced, but there is also the problem that costs are incurred for efficiently selecting propositional logic variables.

The essential reason for introducing temporal logic is to handle even the case in which the reward function in reinforcement learning depends on the past history beyond the Markov decision process in which the “next state” is determined only by the “current state” and “current action”. In this regard, it is conceivable that s representing the current state is extended using sh representing the past history information, and the feature vector f (s, a, s′) could also be extended. In other words,

s→(s,sₕ)

f(s,a,s′)→(f(s,a,s′),fₕ((s,sₕ),a,(s′,s′ₕ))).

In general, however, sₕ is a |P|-dimensional vector associated with the propositional set P and representing the logical values of all the elements of P. Also, fₕ will be a 2^{|P|}-dimensional vector with a feature element that takes a non-zero value only when each of the possible states of sₕ is achieved.

With the above extension, it is possible to express the history dependence of the reward function as in Equation 4 below.

R=(θ,θₕ)^{T}·(f(s,a,s′),fₕ((s,sₕ),a,(s′,s′ₕ))) (Equation 4)

In this case, however, it is necessary to deal with a long feature vector expressed in bits. In general, the larger the number of features, the more difficult it becomes to estimate the correct reward function from expert data. Thus, it is difficult to perform processing such as minimizing multiple competing features.

In response to the above problem, in this exemplary embodiment, since the reward function estimation unit 30 estimates the reward function for each task in time series, the propositional space of possible inter-task transitions and transition conditions is aggregated. Then, the temporal logic structure estimation unit 40 estimates the temporal logic structure, focusing on the point in time when tasks switch. As a result, the search space that the solver should consider becomes very small, and it is possible to speed up the calculation.

When a quantum computer is used in the estimation process, the temporal logic structure estimation unit 40 may transform the model used for estimation into a model used in a quantum computer (for example, an Ising model).

The update unit 50 updates the point in time when the reward function switches so as to maximize a likelihood of the action history of the worker. Specifically, the update unit 50 updates the reward function representing the task by updating the task label in each action history so as to maximize the likelihood of the action history (expert trajectory) while fixing the estimated temporal logic structure.

In general, the estimated temporal logic structure (i.e., the transition structure and transition conditions between tasks) is not 100% compliant, even if the estimation is truly correct, due to the noise included in the real data and the presence of errors in the expert trajectory data. Therefore, the update unit 50 may update the position of the task label assigned to the expert trajectory data (i.e., the point in time when the reward function switches) by sliding the task label at a point in time when the reward function of the task is switched back and forth in the time series.

For example, assume that the series of estimated task labels is “AAABBBCCC”. In this case, updating the point in time when the reward function is switched corresponds to sliding the position of the time step t at which the task switches, for example, “AAAABBCCC”.

By updating the task label, the target data used to estimate the reward function of the task is also updated. That is, for a certain task, the reward function that was estimated for the state and action pairs (sₜ, aₜ) for the time steps from t=i to j, for example, the reward function will be estimated by the state and action pairs (sₜ, aₜ) from t=i to j+Δ. Therefore, the update unit 50 updates the reward function for the task identified by the updated task label so as to maximize the likelihood of the action history. The update unit 50 may, for example, update the task label that maximizes the likelihood from the likelihood calculation related to the temporal logic estimation and the gradient calculation for the task label.

The update unit 50 then determines whether the change in the point in time when the reward function is switched satisfies a predetermined end condition. The update unit 50 may, for example, determine whether the change amount in the task label is below a predetermined threshold value. The change amount in task labels indicates the difference between the series of task labels before the update and the series of task labels after the update. For example, when the series of task labels changes from “AAABBBCCC” to “AAAABBCCC”, the change amount in the task label is 1.

If the predetermined end condition is not satisfied, the estimation process by the temporal logic structure estimation unit 40 is performed, and the update process by the update unit 50 is performed again. On the other hand, if the predetermined end condition is satisfied, the update unit 50 ends the update process. For example, if the change amount in the task label does not exceed the threshold value, the update unit 50 ends the update process. If the task label is not updated, since the reward function of each task, as well as the task structure and transition condition between tasks estimated based on the task label, is also unchanged, it can be said that the end condition focusing on the change amount before and after the update of the task label is sufficient.

The end condition is not limited to the change amount in the task label. The update unit 50 may use as the end condition the change amount in the reward function before and after the update, the change amount in the task structure, or the change amount defined for the transition condition between tasks.

The output unit 60 outputs the estimated temporal logic structure.

The input unit 20, the reward function estimation unit 30, the temporal logic structure estimation unit 40, the update unit 50, and the output unit 60 are realized by a processor (for example, CPU (Central Processing Unit), GPU (Graphics Processing Unit)) of a computer that operates according to a program (a learning program).

For example, a program may be stored in the storage unit 10 of the learning device 100, and the processor may read the program and operate as the input unit 20, the reward function estimation unit 30, the temporal logic structure estimation unit 40, the update unit 50 and the output unit 60 according to the program. In addition, the functions of the learning device 100 may be provided in the form of SaaS (Software as a Service).

In addition, the input unit 20, the reward function estimation unit 30, the temporal logic structure estimation unit 40, the update unit 50 and the output unit 60 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the learning device 100 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

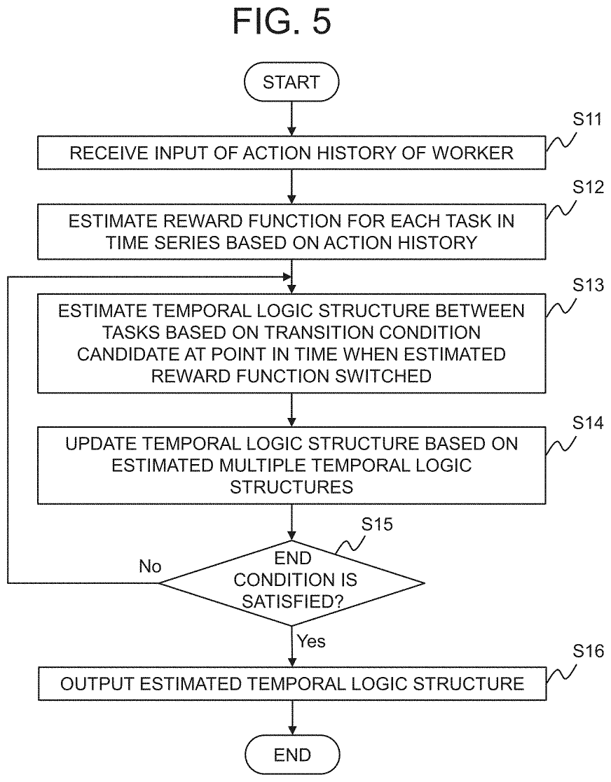

Next, the operation of the learning device 100 of this exemplary embodiment will be described. FIG. 5 is a flowchart showing an operation example of the learning device 100. The input unit 20 receives input of an action history of a worker who performs multiple tasks in time series (step S11). The reward function estimation unit 30 estimates a reward function for each task in the time series based on the received action history (step S12). Then, the temporal logic structure estimation unit 40 estimates a temporal logic structure between tasks based on a transition condition candidate at a point in time when each estimated reward function switched (step S13).

Furthermore, the update unit 50 of the learning device 100 may update the point in time when the reward function switches so as to maximize a likelihood of the action history of the worker (step S14). The update unit 50 then determines whether the change in point in time when the reward function is switched satisfies a predetermined end condition (step S15). If the end condition is not satisfied (No in step S15), the processing after step S13 is repeated. On the other hand, if the end condition is satisfied (Yes in step S15), the output unit 60 outputs the estimated temporal logic structure (step S16).

As described above, in this exemplary embodiment, the input unit 20 receives input of an action history of a worker who performs multiple tasks in time series, and the reward function estimation unit 30 estimates a reward function for each task based on the received action history. Then, the temporal logic structure estimation unit 40 estimates a temporal logic structure between tasks based on a transition condition candidate at a point in time when each estimated reward function switches. Therefore, it is possible to efficiently estimate a reward function considering temporal logic structure between tasks.

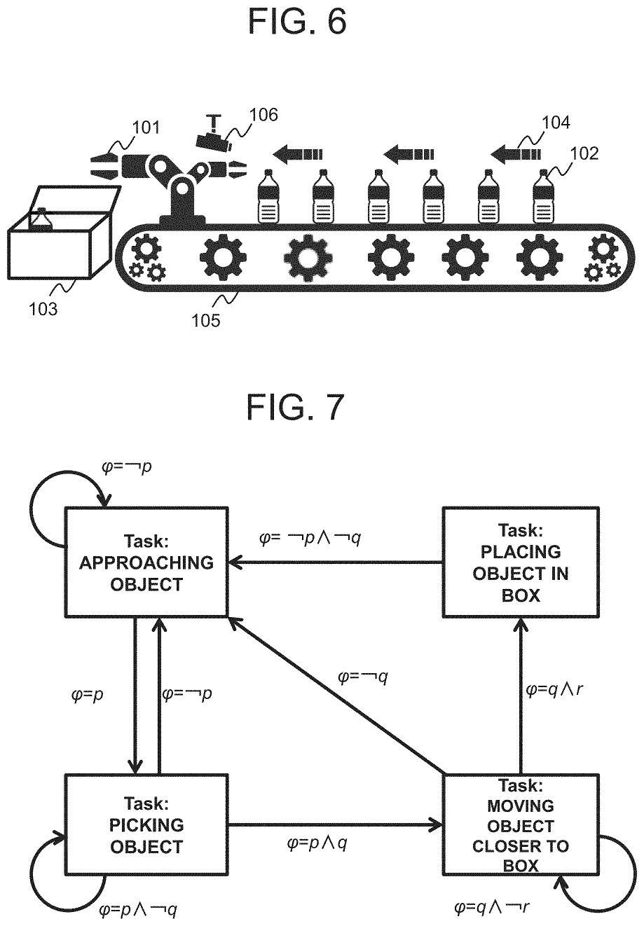

Next, a specific example of this exemplary embodiment is described. FIG. 6 is an explanatory diagram showing a specific example of a temporal logic task. In the specific example, as illustrated in FIG. 6, it is assumed that a situation in which the robot arm (hereinafter, simply written as arm) 101 described above picks a bottle 102, which is an object, and places it in a box 103 (Pick and Place). Specifically, in a situation where the bottle 102 moves on a conveyor belt 105 moving in the direction of the arrow 104, the arm 101 performs the task based on the image taken by the camera 106. Here, it is assumed that the task by the robot arm 101 can be broadly classified into the following four categories
(1) Approaching the object (Arm 101)
(2) Picking the object
(3) Moving the object closer to the box
(4) Placing the object in the box

First, the input unit 20 received input of the action history τ={(s₀, a₀), (s₁, a₁), . . . } as the learning data. As described above, the input unit 20 receives camera images of the distance to the object captured by the camera 106 and the information indicating the state of each arm 101 as state s, and the torque of arm 101 as action a.

Next, the reward function estimation unit 30 estimates the reward function in time series. Specifically, the reward function estimation unit 30 estimates the time period during which actions are combined into one and the reward function corresponding to that time period. As a result, the action history is classified into four tasks, and the reward functions for the tasks (1) to (4) above are estimated.

The temporal logic structure estimation unit 40 estimates the transition structure and transition conditions for each of the estimated actions. FIG. 7 is an explanatory diagram showing examples of an estimated transition structure and a transition condition. For example, in the task of the above (1), when φ=¬p (i.e., “the distance between the object (bottle 102) and the arm 101 is not less than X”), the task of the above (1) is repeated, and when φ=p (i.e., the distance between the object (bottle 102) and the arm 101 is less than X″), the transition to the task of the above (2) is indicated. The same is true for the others.

The update unit 50 updates the reward function by sliding the point in time when the reward function switches. The update unit 50 updates the reward function so as to be more preferable by, for example, sliding the position at the point in time when the task of “approaching the object” (i.e., task (1)) and the task of “picking the object” (i.e., task (2)) are switched back and forth. This is repeated until the end condition is satisfied.

Next, another specific example of this exemplary embodiment is described. Temporal logic not only deals with the order of tasks, for example, “Task-A followed by Task-B,” but also deals with constraint conditions, such as “Perform Task-A while maintaining Condition X” or “After finishing Task-A, always perform Task-B while observing condition X”, etc.

For example, in automatic driving, “keep in the left lane all the way” or “after entering a priority road, go straight without pausing at an intersection until you exit the road” can be described by temporal logic. To achieve automatic driving that more adequately simulates human driving, it is necessary to go beyond the general framework of inverse reinforcement learning and use inverse reinforcement learning that can deal with temporal logic tasks.

The inverse reinforcement learning by the learning device 100 in this exemplary embodiment deals with a temporal logic task. Therefore, it is possible to estimate a reward function considering the constraint conditions as described above.

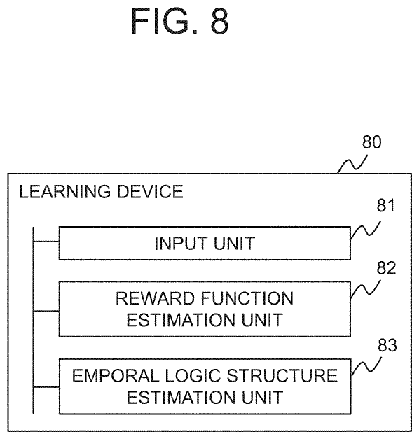

Next, an overview of the present invention will be described. FIG. 8 is a block diagram showing an overview of a learning device according to the present invention. The learning device 80 (for example, the learning device 100) according to the present invention comprises an input unit 81 (for example, the input unit 20) which receives input of an action history (for example, trajectories τ, data D) of a worker who performs multiple tasks (for example, tasks) in time series, a reward function estimation unit 82 (for example, the reward function estimation unit 30) which estimates a reward function for each task in time series based on the action history, and a temporal logic structure estimation unit 83 (for example, the temporal logic structure estimation unit 40) which estimates a temporal logic structure between tasks based on a transition condition candidate at a point in time when each estimated reward function switched.

With such a configuration, it is possible to efficiently estimate a reward function considering temporal logic structure between tasks.

The learning device 80 may also comprise an update unit (for example, the update unit 50) which updates the point in time when the reward function switches so as to maximize a likelihood of the action history of the worker.

Specifically, the reward function estimation unit 82 may assign task labels that identify tasks to the corresponding action history in time series, and the update unit may update the point in time when the reward function switches by sliding the task label at the point in time when the reward function switches back and forth in the time series, and update the reward function corresponding to the task identified by the updated task label so as to maximize the likelihood of the action history of the worker.

The temporal logic structure estimation unit 83 may also estimate a transition condition between tasks expressed in a logical formula using a propositional logic variable derived in advance from a domain knowledge to be learned by solving using a solver (a SAT solver) of a satisfiability problem.

Otherwise, the temporal logic structure estimation unit 83 may estimate a transition condition between tasks expressed in a logical formula using a propositional logic variable derived in advance from a domain knowledge to be learned by calculating a transition probability between the tasks.

The reward function estimation unit 82 may also learn sequentially a plurality of reward functions for each task from a data series indicating the action of the worker included in the action history by time series inverse reinforcement learning.

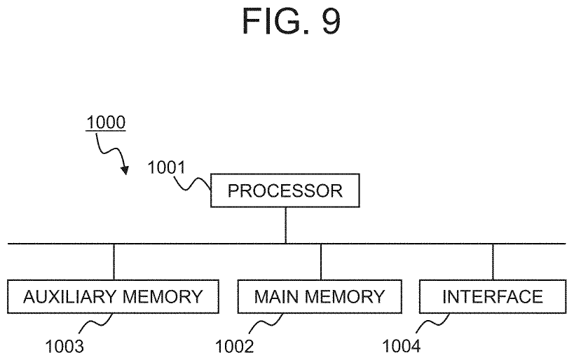

FIG. 9 is a summarized block diagram showing a configuration of a computer for at least one exemplary embodiment. The computer 1000 comprises a processor 1001, a main memory 1002, an auxiliary memory 1003, and an interface 1004.

The above-described learning device 80 is implemented in the computer 1000. The operation of each of the above-described processing units are stored in the auxiliary memory 1003 in a form of a program (learning program). The processor 1001 reads the program from the auxiliary memory 1003, deploys the program to the main memory 2002, and executes the above-described processing according to the program.

In at least one exemplary embodiment, the auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 1000 through a communication line, the computer 1000 receiving the transmission may deploy the program to the main memory 1002 and perform the above process.

The program may also be one for realizing some of the aforementioned functions. Furthermore, said program may be a so-called differential file (differential program), which realizes the aforementioned functions in combination with other programs already stored in the auxiliary memory 1003.

### INDUSTRIAL APPLICABILITY

The present invention is suitably applied to a learning device for estimating a reward function considering temporal logic structure. For example, the present invention can be suitably applied to robotics for working in a warehouse or a factory, automatic operation of a plant, automation of RPA (robotic process automation), and a learning device for estimating a reward function used in a game.

### REFERENCE SIGNS LIST

10 Storage unit
20 Input unit
30 Reward function estimation unit
40 Temporal logic structure estimation unit
50 Update unit
60 Output unit

What is claimed is:

1. A learning device comprising:
a memory storing instructions; and
one or more processors configured to execute the instructions to:
receive input of an action history of a worker who performs multiple tasks in time series;
estimate a reward function for each task in time series based on the action history; and
estimate a temporal logic structure between tasks based on a transition condition candidate at a point in time when each estimated reward function switched.

2. The learning device according to claim 1, wherein the processor further executes instructions to
update the point in time when the reward function switches so as to maximize a likelihood of the action history of the worker.

3. The learning device according to claim 2, wherein the processor further executes instructions to:
assign task labels that identify tasks to the corresponding action history in time series; and
update the point in time when the reward function switches by sliding the task label at the point in time when the reward function switches back and forth in the time series, and update the reward function corresponding to the task identified by the updated task label so as to maximize the likelihood of the action history of the worker.

4. The learning device according to claim 1, wherein the processor further executes instructions to
estimate a transition condition between tasks expressed in a logical formula using a propositional logic variable derived in advance from a domain knowledge to be learned by solving using a solver of a satisfiability problem.

5. The learning device according to claim 1, wherein the processor further executes instructions to
estimate a transition condition between tasks expressed in a logical formula using a propositional logic variable derived in advance from a domain knowledge to be learned by calculating a transition probability between the tasks.

6. The learning device according to claim 1, wherein the processor further executes instructions to
learn sequentially a plurality of reward functions for each task from a data series indicating the action of the worker included in the action history by time series inverse reinforcement learning.

7. A learning method comprising:
receiving input of an action history of a worker who performs multiple tasks in time series;
estimating a reward function for each task in time series based on the action history; and
estimating a temporal logic structure between tasks based on a transition condition candidate at a point in time when each estimated reward function switched.

8. The learning method according to claim 7, wherein
updating the point in time when the reward function switches so as to maximize a likelihood of the action history of the worker.

9. A non-transitory computer readable information recording medium storing a learning program, when executed by a processor, that performs a method for:
receiving input of an action history of a worker who performs multiple tasks in time series;
estimating a reward function for each task in time series based on the action history; and
estimating a temporal logic structure between tasks based on a transition condition candidate at a point in time when each estimated reward function switched.

10. The non-transitory computer readable information recording medium according to claim 9, further comprising
updating the point in time when the reward function switches so as to maximize a likelihood of the action history of the worker.
